(19) United States
(12) Patent Application Publication
(10) Pub. No.: US 2020/0247153 A1
(43) Pub. Date: Aug. 6, 2020

(54) PRINTING APPARATUS

(71) Applicant: MITSUBISHI ELECTRIC CORPORATION, Tokyo (JP)

(72) Inventor: Kosuke ODA, Tokyo (JP)

(73) Assignee: MITSUBISHI ELECTRIC CORPORATION, Tokyo (JP)

(21) Appl. No.: 16/652,331

(22) PCT Filed: Dec. 25, 2017
(86) PCT No.: PCT/JP2017/046339

§ 371 Date: Mar. 30, 2020

(51) Int. Cl. B41J 15/04; B65H 16/06

(52) U.S. Cl. CPC B41J 15/042; B65H 19/126; B65H 16/06

(57) ABSTRACT

In a movable portion state being a state of a print movable portion including a roll core holder unit configured to support one end portion and another end portion of a roll core, there exist an open state and a closed state. The print movable portion is configured to be movable so that the movable portion state is the open state or the closed state. The roll core holder unit is provided with a support portion. In a support state in which the support portion supports the one end portion and the another end portion, as the movable portion state transitions from the open state to the closed state, a first fitting portion fits into the one end portion and a second fitting portion fits into the another end portion.

### TECHNICAL FIELD

The present invention relates to a printing apparatus having a configuration using a paper roll.

### BACKGROUND ART

Paper rolls are used in printing apparatuses such as business printers, copying machines, and facsimile machines. The paper roll is configured by winding long paper into a roll. The long paper is a medium (printing paper) on which printing is performed. Hereinafter, processing for forming an image on paper is also referred to as “printing processing”.

In order for a printing apparatus using a paper roll to perform a printing processing, it is necessary to first attach the paper roll to a paper holder. In addition, when the paper roll runs out, it is necessary to attach a new paper roll to the paper holder. That is, the paper roll is a consumable item. That is, since the paper roll is frequently replenished, it is desirable that even a user unfamiliar with the operation of the printing apparatus can easily attach the paper roll to the printing apparatus.

It should be noted that thermal transfer type printing apparatuses also include an apparatus having a function of performing color printing processing. The thermal transfer method includes a sublimation method and a melting method. In the color printing processing, the printing apparatus sequentially transfers a plurality of types of dyes (inks) onto paper. Each of the plurality of types of dyes exhibits colors such as yellow, magenta, and cyan. Therefore, in the color printing processing, the printing apparatus moves paper in the conveyance direction or the reverse conveyance direction in the printing apparatus. That is, in the color printing processing, the printing apparatus repeatedly performs processing of conveying paper by rotating the paper roll forward or backward. Thus, a color image is formed on the paper.

Such a printing apparatus performs processing of rotating the paper roll in synchronization with the operation of a transfer portion in the printing apparatus. In this process, it is necessary to transmit the rotational power generated by the printing apparatus to the paper roll.

As a configuration for transmitting rotational power to a paper roll, a configuration using a paper flange provided with a gear is common. In the configuration using a paper flange, the user fixes the paper flange to the side surface of the paper roll, and then attaches the paper flange to the printing apparatus.

However, it takes time and effort for the user to attach the paper flange to the paper roll. Therefore, a configuration in which the user can easily attach the paper flange to the paper roll (hereinafter also referred to as “easily attaching configuration”) is desired. The easily attaching configuration is necessary for the user to easily attach the paper roll to the printing apparatus.

From such a viewpoint, various easily attaching configurations have been proposed. Japanese Patent Application Laid-Open No. 2006-205540 discloses a configuration in which two flanges are attached to a roll paper (paper roll) (hereinafter also referred to as “related configuration A”) as an easily attaching configuration.

In the related configuration A, connecting the two support shafts held in the two flanges allows the two flanges to be attached to the roll paper. In addition, in the related configuration A, a groove is provided on the surface of a support shaft of one of the flanges. The roller is held in the groove so as to be movable in the groove. Using the roller allows a paper tube of roll paper to be easily inserted into the support shaft of one flange.

In addition, Japanese Patent Application Laid-Open No. 2009-143020 discloses a configuration for preventing the roll paper from fraying (hereinafter also referred to as “related configuration B”) with the guide plate (paper flange) attached to the roll paper (paper roll). The related configuration B is provided with a fraying prevention mechanism on the guide plate. The presence of the fraying prevention mechanism prevents the roll paper from fraying. Thus, the user can easily perform the roll paper replacement operation.

On the other hand, there is also a printing apparatus that does not need to perform the rotational operation of the paper roll when forming an image on the paper (hereinafter also referred to as “printing apparatus N”). The printing apparatus N includes a monochrome printing apparatus that performs printing on thermal paper, for example. In addition, the printing apparatus N includes an ink jet type color printing apparatus, for example. The printing apparatus N does not need to have a configuration for transmitting rotational power to the paper roll. That is, in the printing apparatus N, the paper flange does not need to be attached to the paper roll. Therefore, time and effort of attaching the paper flange are unnecessary.

However, in order to improve user convenience, it is desirable that the printing apparatus N has a configuration in which a paper roll can be easily attached to the printing apparatus N.

Thus, Japanese Patent Application Laid-Open No. 2000-177889 discloses a configuration for holding roll paper (paper roll) without using a support shaft (paper flange) (hereinafter also referred to as “related configuration C”). In the related configuration C, a roll paper holder configured to be elastically deformed holds the roll paper. According to the roll paper holder, the roll paper can be easily attached and detached.

### SUMMARY

### Problem to be Solved by the Invention

The printing apparatus using a paper roll includes an apparatus including a roll core holder unit for supporting a roll core fixed to the paper roll. In such a printing apparatus, it is desirable that the paper roll can be easily attached to the printing apparatus.

In order to easily attach the paper roll to the printing apparatus, a configuration for holding the roll core in a state where the roll core holder unit supports the roll core is required. The related configurations A, B, and C cannot meet this requirement.

The present invention has been made to solve this problem, and has an object to provide a printing apparatus, in a state where a roll core holder unit supports a roll core, having a configuration for holding the roll core.

### Means to Solve the Problem

In order to achieve the above object, the printing apparatus according to one aspect of the present invention uses a paper roll configured by winding long paper around a cylindrical roll core in a roll-shaped manner, and has a function of forming an image on the paper. The printing apparatus includes: a print movable portion having a configuration for holding the paper roll; and a housing for accommodating the print movable portion. The print movable portion includes: a roll core holder unit configured to support one end portion and another end portion of the roll core, a first fitting portion for fitting into the one end portion of the roll core, and a second fitting portion for fitting into the other end portion of the roll core. In a movable portion state being a state of the print movable portion, there exist an open state where the roll core holder unit is not covered by the housing and a closed state where the roll core holder unit is covered by the housing. The print movable portion is configured to be movable so that the movable portion state is the open state or the closed state. The roll core holder unit is provided with a support portion for supporting the one end portion and the other end portion of the roll core. In a state of the support portion, there exist a support state in which the support portion supports the one end portion and the other end portion, and a non-support state in which the support portion does not support two or one of the one end portion and the other end portion. Each of the first fitting portion and the second fitting portion is configured to be rotatable. In the support state, as the movable portion state transitions from the open state to the closed state, the first fitting portion fits into the one end portion and the second fitting portion fits into the other end portion.

### Effects of the Invention

According to the present invention, in the movable portion state being a state of the print movable portion including the roll core holder unit configured to support the one end portion and the other end portion of the roll core, there exist an open state and a closed state. The print movable portion is configured to be movable so that the movable portion state is the open state or the closed state. The roll core holder unit is provided with a support portion. In a support state in which the support portion supports the one end portion and the other end portion, as the movable portion state transitions from the open state to the closed state, the first fitting portion fits into the one end portion and the second fitting portion fits into the other end portion.

Thus, it is possible to provide a printing apparatus having a configuration for holding the roll core in a state where the roll core holder unit supports the roll core.

The objects, characteristics, aspects, and advantages of the present invention will become more apparent from the following detailed description and the accompanying drawings.

### BRIEF DESCRIPTION OF DRAWINGS

FIG. 1 is a diagram showing a main configuration of a printing apparatus according to a first embodiment.

FIG. 2 is a perspective view showing the appearance of the paper roll.

FIG. 3 is a diagram showing a state where a print movable portion has moved.

FIG. 4 is a perspective view showing a configuration of a roll holding portion.

FIG. 5 is a perspective view showing a configuration of a roll core holder unit.

FIG. 6 is a diagram showing a configuration in which a state of the support portion of the roll core holder unit is the support state.

FIG. 7 is a diagram showing a form of the drive units when the movable portion state is the closed state.

FIGS. 8A and 8B are perspective views of the drive unit according to the first embodiment.

FIG. 9 is a side view of the drive unit in the closed state.

FIG. 10 is a top view of the drive unit in the closed state.

FIG. 11 is a diagram showing a configuration of the fitting portion according to the first embodiment.

FIG. 12 is a perspective view showing a configuration of a biasing portion.

FIG. 13 is another perspective view showing the configuration of the biasing portion.

FIG. 14 is a diagram showing the force for moving a fitting portion.

FIGS. 15A and 15B are diagrams for illustrating the configuration of the roll core holder according to the first embodiment.

FIG. 16 is a cross-sectional view of the drive unit and the roll core.

FIG. 17 is a flowchart for illustrating an attaching operation.

FIG. 18 is a flowchart of the attached state determination processing according to the first embodiment.

FIGS. 19A and 19B are diagrams showing the roll core holder of the roll core holder unit according to the first modification.

### DESCRIPTION OF EMBODIMENTS

Hereinafter, embodiments of the present invention will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions, material, and shape of each component, relative arrangement of each component, and the like exemplified in the embodiments may be appropriately changed according to the configuration, various conditions, and the like of the apparatus to which the present invention is applied. In addition, the dimensions of each component in each drawing may differ from the actual dimensions.

### First Embodiment

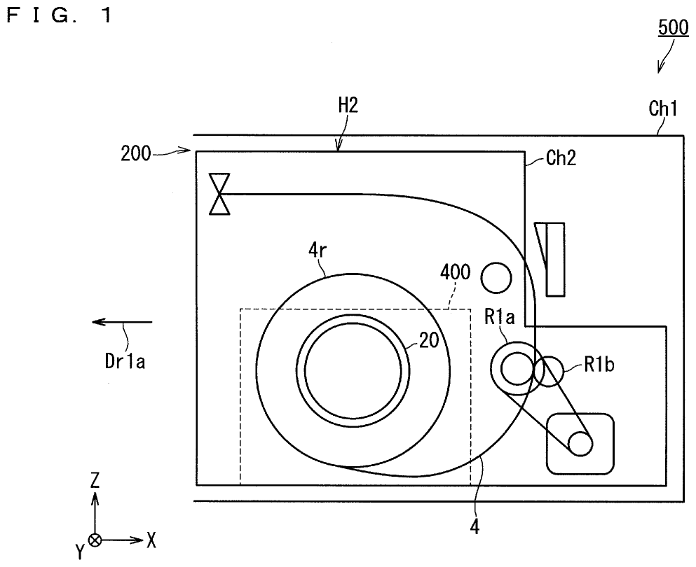

FIG. 1 is a diagram showing a main configuration of a printing apparatus 500 according to a first embodiment. The printing apparatus 500 is a thermal transfer type printer, for example. It should be noted that in FIG. 1, a roll holding portion 400 described below is simply indicated by a dotted line.

In FIG. 1, the X direction, the Y direction, and the Z direction are orthogonal to one another. The X, Y, and Z directions illustrated in the following drawings are also orthogonal to one another. Hereinafter, a direction including the X direction and a direction opposite to the X direction (−X direction) is also referred to as “X-axis direction”. In addition, hereinafter, a direction including the Y direction and a direction opposite to the Y direction (−Y direction) is also referred to as “Y-axis direction”. In addition, hereinafter, a direction including the Z direction and a direction opposite to the Z direction (−Z direction) is also referred to as “Z-axis direction”.

In addition, hereinafter, a plane including the X-axis direction and the Y-axis direction is also referred to as “XY plane”. In addition, hereinafter, a plane including the X-axis direction and the Z-axis direction is also referred to as “XZ plane”. In addition, hereinafter, a plane including the Y-axis direction and the Z-axis direction is also referred to as “YZ plane”.

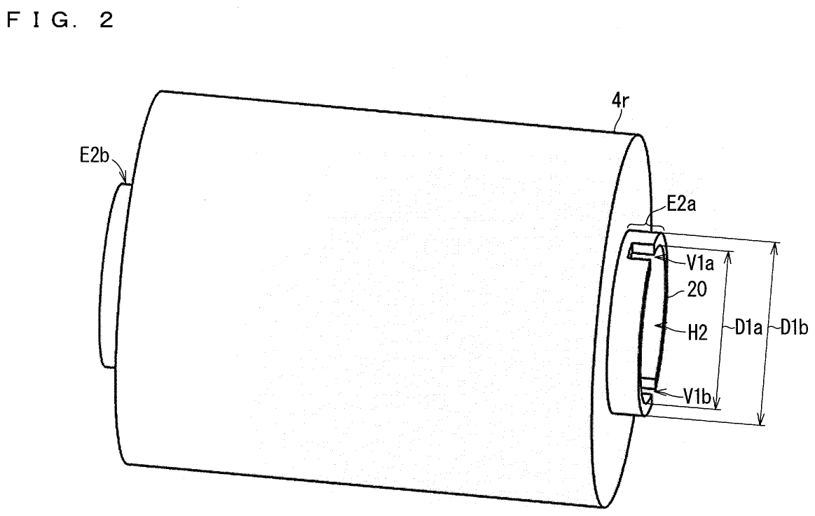

Referring to FIG. 1, a printing apparatus 500 has a function of performing printing processing by using a paper roll 4r. That is, the printing apparatus 500 has a function of forming an image on paper 4. FIG. 2 is a perspective view showing the appearance of the paper roll 4r.

Referring to FIGS. 1 and 2, the paper roll 4r is fixed to a roll core 20. The roll core 20 has a cylindrical shape. The roll core 20 has a hole H2. In addition, the shape of the side surface of the roll core 20 is a circle. In addition, the shape of the roll core 20 is a long shape. The roll core 20 has end portions E2a and E2b.

The paper roll 4r is configured by winding long paper 4 around the roll core 20 in a roll-shaped manner. The paper 4 is printing paper for performing printing. It should be noted that the roll core 20 is integrated with the paper roll 4r in a state of being inserted into the inner diameter portion of the paper roll 4r. It should be noted that the length of the long side of the roll core 20 is longer than the width of the paper 4.

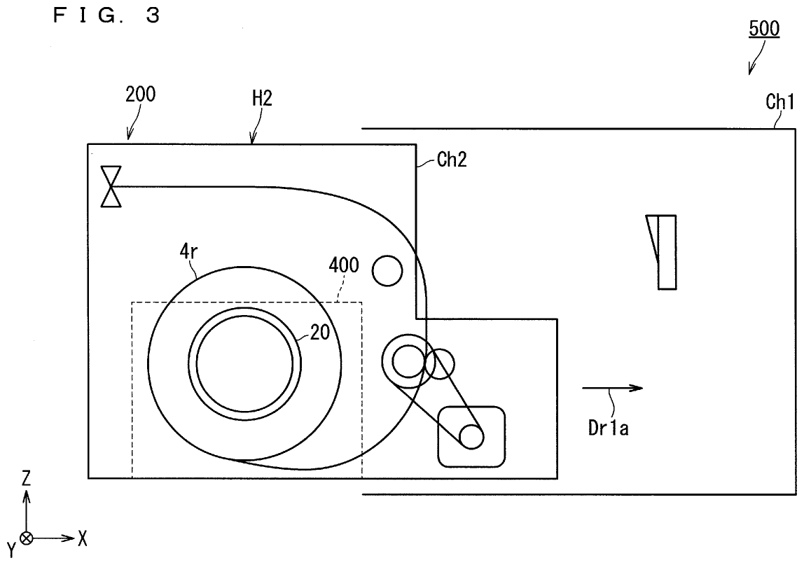

The printing apparatus 500 includes a housing Ch1 and a print movable portion 200. The housing Ch1 is a member for accommodating the print movable portion 200. The print movable portion 200 is configured to be movable in the horizontal direction (X-axis direction). FIG. 3 shows a state where the print movable portion 200 in FIG. 1 has moved in the direction Dr1a (−X direction).

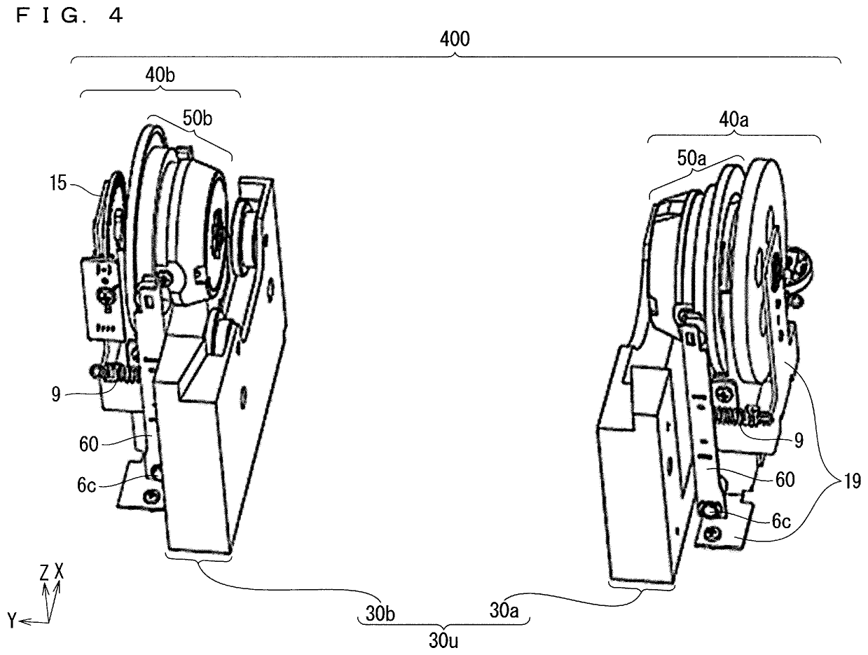

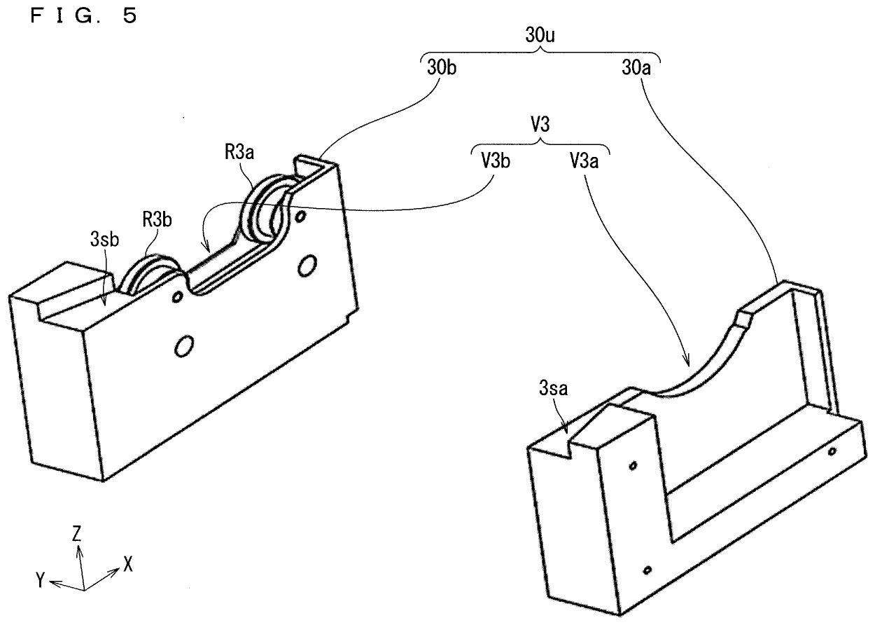

The print movable portion 200 includes a housing Ch2 and the roll holding portion 400 in FIG. 4. The roll holding portion 400 is fixed to the housing Ch2. An opening H2 is provided in the upper portion of the housing Ch2. The housing Ch2 accommodates the roll holding portion 400. The roll holding portion 400 has a configuration for holding the paper roll 4r. The roll holding portion 400 includes a roll core holder unit 30u in FIG. 5. That is, the housing Ch2 accommodates the roll core holder unit 30u.

The roll core holder unit 30u temporarily supports the roll core 20 so that the end portions E2a and E2b of the roll core 20 are rotatable during the period for attaching the paper roll 4r to the printing apparatus 500. The roll core holder unit 30u is configured to support the end portion E2a and the end portion E2b of the roll core 20.

Referring to FIG. 5, the roll core holder unit 30u includes roll core holders 30a and 30b. The roll core holder 30a is a member for supporting the end portion E2a of the roll core 20. The roll core holder 30b is a member for supporting the end portion E2b of the roll core 20.

In addition, the roll core holder unit 30u is provided with a support portion V3. The support portion V3 is a recess for supporting the end portion E2a and the end portion E2b of the roll core 20. The state of the support portion V3 includes a support state and a non-support state. The support state is a state in which the support portion V3 supports the end portion E2a and the end portion E2b. The non-support state is a state in which the support portion V3 does not support both or one of the end portion E2a and the end portion E2b.

The support portion V3 includes support portions V3a and V3b. The support portion V3a is configured to support the end portion E2a of the roll core 20. The support portion V3a is a recess. The roll core holder 30a is provided with the support portion V3a.

The roll core holder 30b is provided with a slope 3sb. In addition, the roll core holder 30b is provided with rollers R3a and R3b for supporting the end portion E2b of the roll core 20. Each of the rollers R3a and R3b is configured to be rotatable. The rollers R3a and R3b are provided on the roll core holder 30b so as to constitute the support portion V3b as a recess.

It should be noted that the above-described support state is a state where the support portion V3a supports the end portion E2a and the support portion V3b supports the end portion E2b. In addition, the non-support state is a state where both or one of the state where the support portion V3a does not support the end portion E2a and the state where the support portion V3b does not support the end portion E2b occurs.

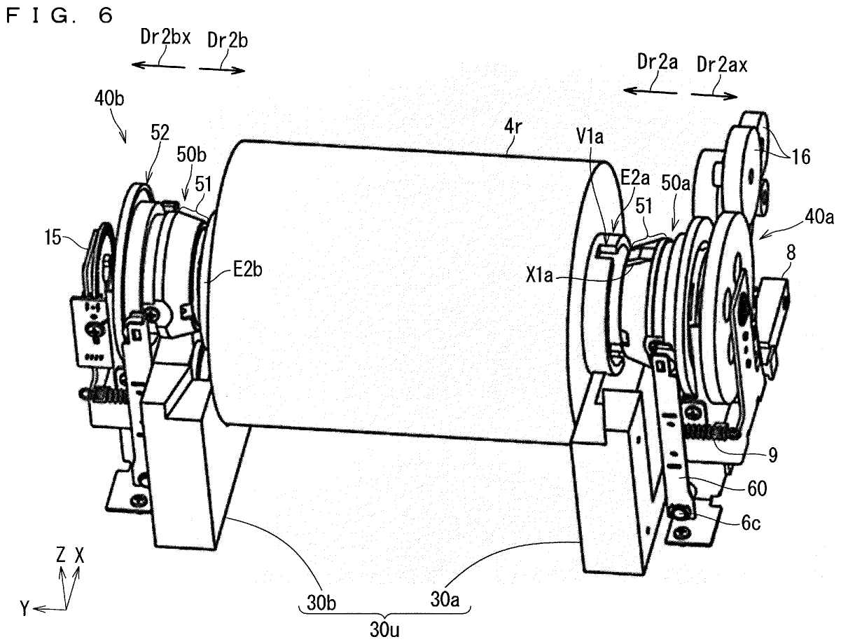

FIG. 6 is a diagram showing a configuration in which a state of the support portion V3 of the roll core holder unit 30u is the support state. Hereinafter, the state of the print movable portion 200 is also referred to as “movable portion state”. The movable portion state includes an open state and a closed state. The open state is a state where the roll core holder unit 30u accommodated in the housing Ch2 is not covered with the housing Ch1. FIG. 3 shows a configuration of the printing apparatus 500 in the open state. The print movable portion 200 is configured to be movable so that the movable portion state is the open state or the closed state.

An opening H2 is provided in the upper portion of the housing Ch2. The opening H2 is provided so that the entire roll core holder unit 30u is exposed to the outside of the housing Ch2. Therefore, in the open state, the roll core holder unit 30u accommodated in the housing Ch2 is not covered with the housing Ch1. That is, in the open state, the roll core holder unit 30u is exposed to the outside. Therefore, in the open state, the user can place the roll core 20 (paper roll 4r) on the roll core holder unit 30u so that the roll core holder unit 30u supports the end portion E2a and the end portion E2b of the roll core 20.

The closed state is a state where the roll core holder unit 30u is covered with the housing Ch1. FIG. 1 shows a configuration of the printing apparatus 500 in the closed state.

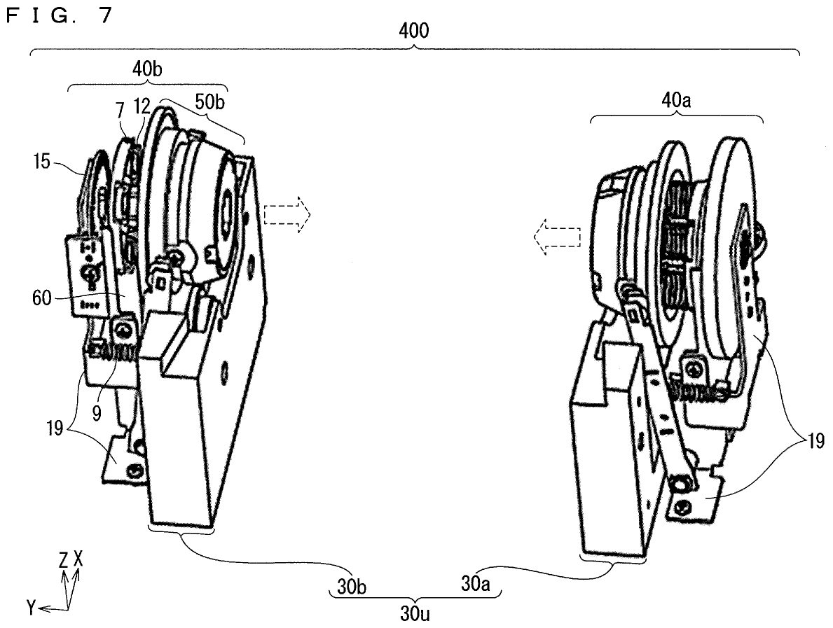

In addition, referring to FIG. 4, the roll holding portion 400 further includes drive units 40a and 40b. The form of each of the drive units 40a and 40b changes according to the movable portion state. FIG. 4 shows a form of the drive units 40a and 40b when the movable portion state is the open state. FIG. 7 shows a form of the drive units 40a and 40b when the movable portion state is the closed state.

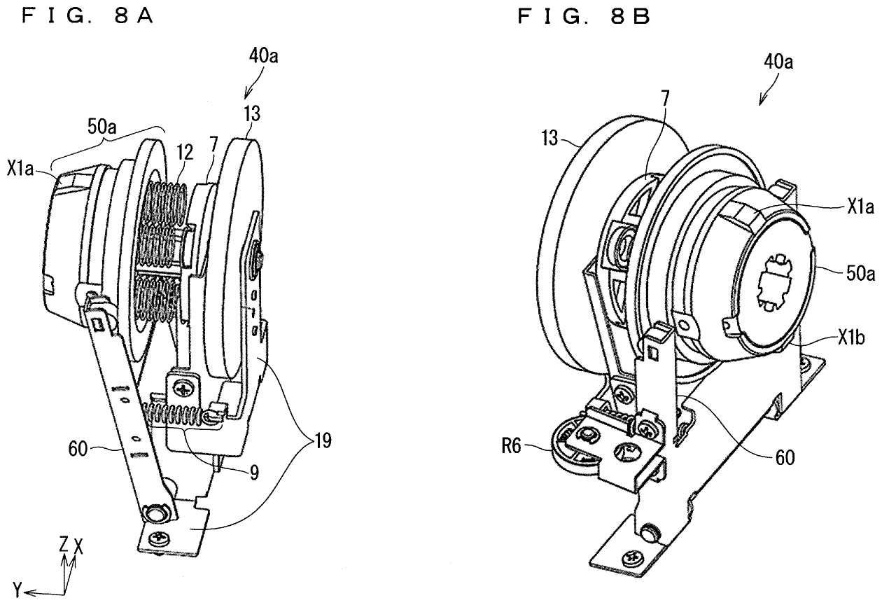

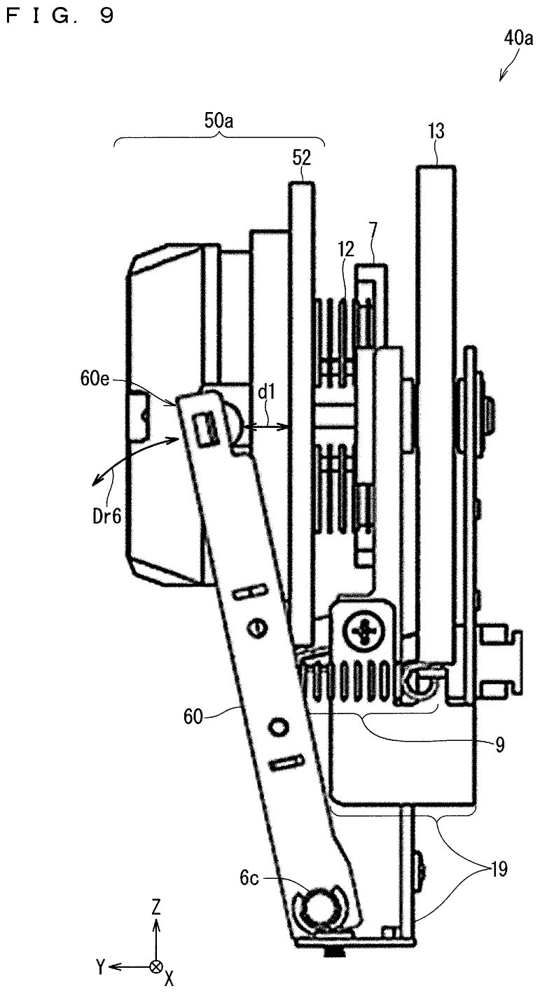

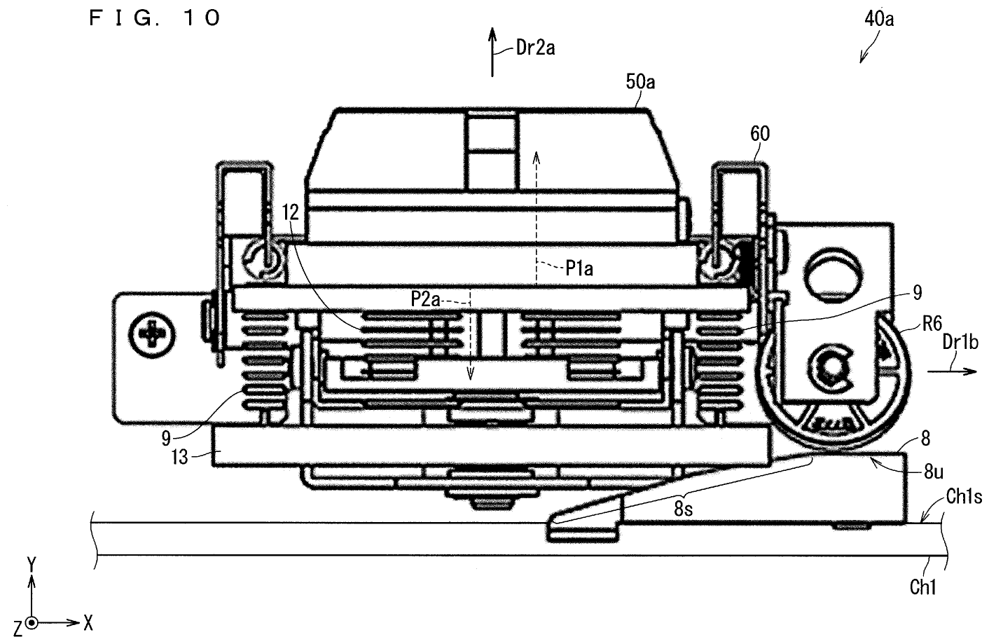

Next, the drive unit 40a will be described. FIGS. 8A and 8B are perspective views of the drive unit 40a according to the first embodiment. FIG. 8A is a perspective view on the side surface side of the drive unit 40a. FIG. 8B is a perspective view on the front surface side of the drive unit 40a. FIG. 9 is a side view of the drive unit 40a in the closed state. FIG. 10 is a top view of the drive unit 40a in the closed state.

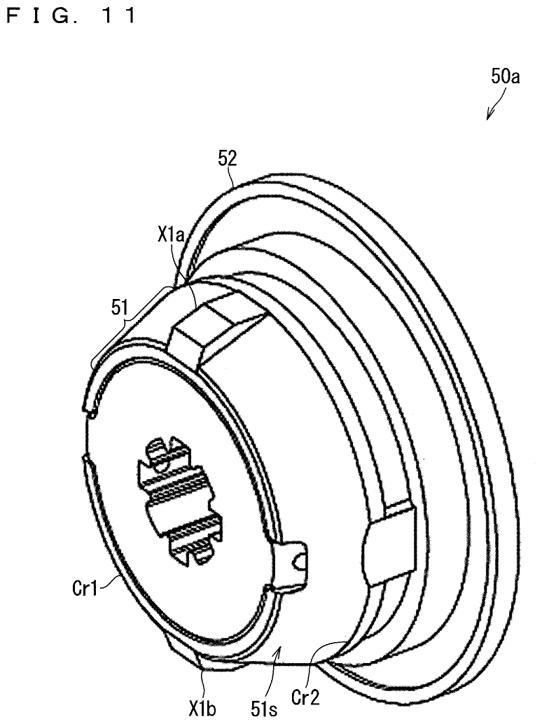

With reference to FIGS. 8A, 8B, 9 and 10, the drive unit 40a includes a fitting portion 50a, a holding portion 7, a drive gear 13, a biasing portion 12, a base portion 19, and a biasing portion 60. FIG. 11 is a diagram showing a configuration of the fitting portion 50a according to the first embodiment. The fitting portion 50a is a member for fitting into the end portion E2a of the roll core 20.

To the base portion 19, the holding portion 7, the drive gear 13, and the fitting portion 50a are fixed. The holding portion 7, the drive gear 13, and the fitting portion 50a are configured to be rotatable. The holding portion 7 and the fitting portion 50a rotate as the drive gear 13 rotates.

The drive gear 13 is configured to rotate along with the rotation of the drive gear 16 in FIG. 6. The drive gear 16 is configured to rotate by a motor (not shown) or the like, for example. The printing apparatus 500 controls drive of a motor (not shown). Therefore, the rotational power generated by the printing apparatus 500 (motor) is transmitted to the fitting portion 50a via the drive gear 16 and the drive gear 13.

Hereinafter, the direction in which the fitting portion 50a approaches the end portion E2a in the support state is also referred to as “direction Dr2a” or “Dr2a”. In addition, the biasing portion 12 is fixed to the fitting portion 50a. The biasing portion 12 is an elastic member. The biasing portion 12 is a spring, for example. In the open state, the biasing portion 12 generates a force in the direction Dr2a on the fitting portion 50a with the biasing portion 12 in contact with the holding portion 7.

Hereinafter, the force for moving the fitting portion 50a in the direction Dr2a is also referred to as “force P1a” or “P1a”. That is, the biasing portion 12 is a member that generates the force P1a in the direction Dr2a. In the support state, the biasing portion 12 generates the force P1a regardless of the open state or the closed state.

Referring to FIG. 11, the fitting portion 50a includes a circular truncated cone portion 51 and a rim portion 52. The circular truncated cone portion 51 includes a slope 51s. The shape of the circular truncated cone portion 51 is a circular truncated cone. The circular truncated cone includes a circle Cr1 and a circle Cr2. The circle Cr2 is larger than the circle Cr1. The diameter of the circle Cr1 is smaller than the inner diameter D1a of the roll core 20. The diameter of the circle Cr2 is larger than the outer diameter D1b of the roll core 20. It should be noted that the fitting portion 50b described below also includes a circular truncated cone portion 51 and a rim portion 52 as with the fitting portion 50a.

It should be noted that as shown in FIGS. 2 and 6, the end portion E2a of the roll core 20 is provided with recessed portions V1a and V1b. In addition, as shown in FIGS. 6, 8B, and 11, the fitting portion 50a is provided with protruding portions X1a and X1b. Specifically, the protruding portions X1a and X1b are provided on the surface of the circular truncated cone portion 51. When the movable portion state is the closed state, the protruding portion X1a fits into the recessed portion V1a, and the protruding portion X1b fits into the recessed portion V1b. Thus, the rotational power of the fitting portion 50a is applied to the roll core 20.

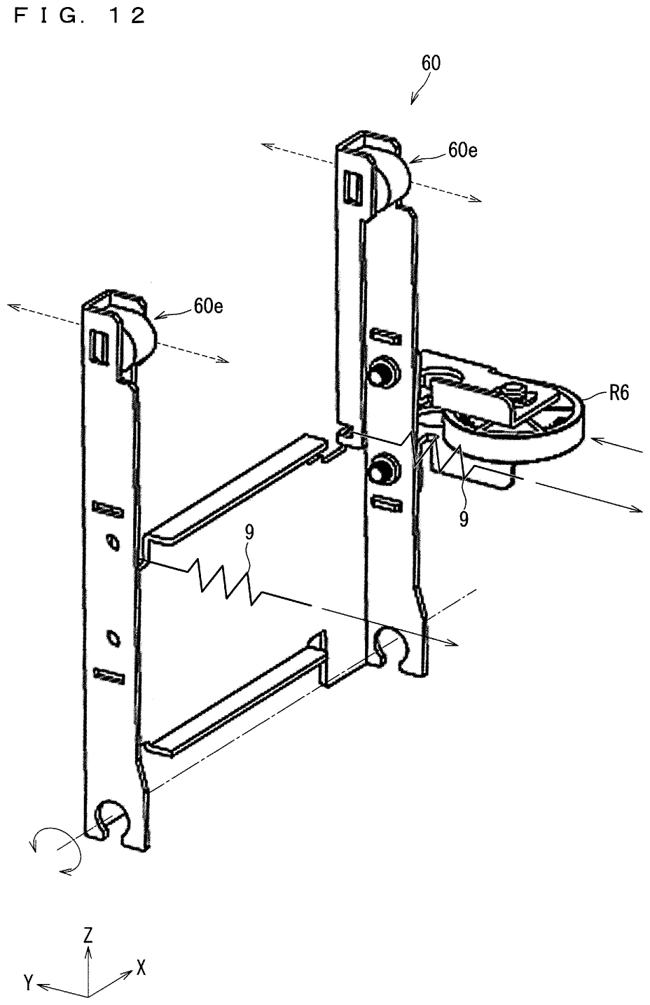

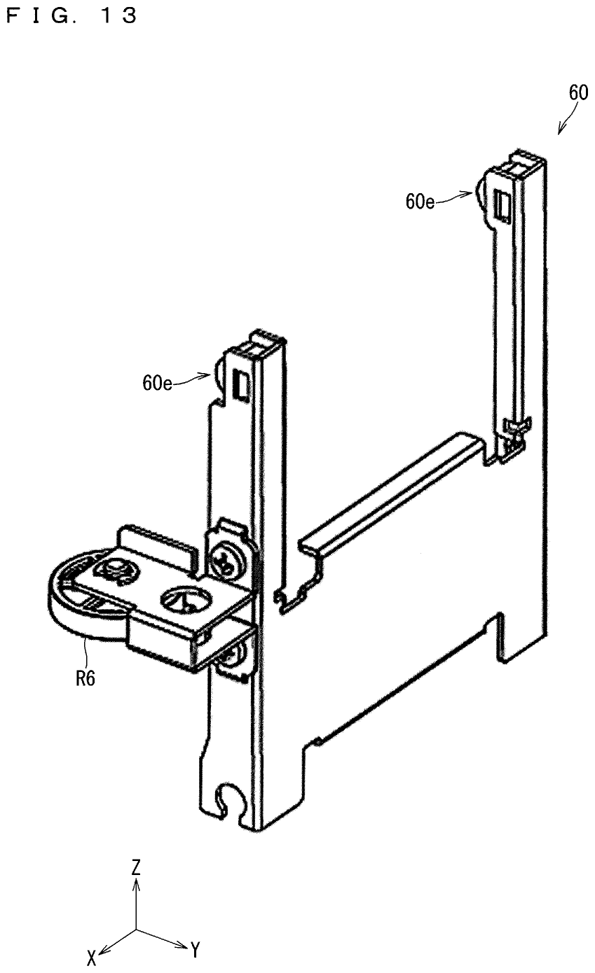

FIGS. 12 and 13 are perspective views showing the configuration of the biasing portion 60. It should be noted that in FIG. 12, a simplified spring 9 is shown. A follower R6 is fixed to the biasing portion 60. The follower R6 is a disc-shaped member. The follower R6 is configured to be rotatable.

The biasing portion 60 includes an end portion 60e. Referring to FIG. 9, the biasing portion 60 is fixed to the base portion 19 via a shaft 6c. The biasing portion 60 is configured so that the end portion 60e is movable along the direction Dr6. That is, the biasing portion 60 is configured to be rotatable with the shaft 6c as a rotating shaft.

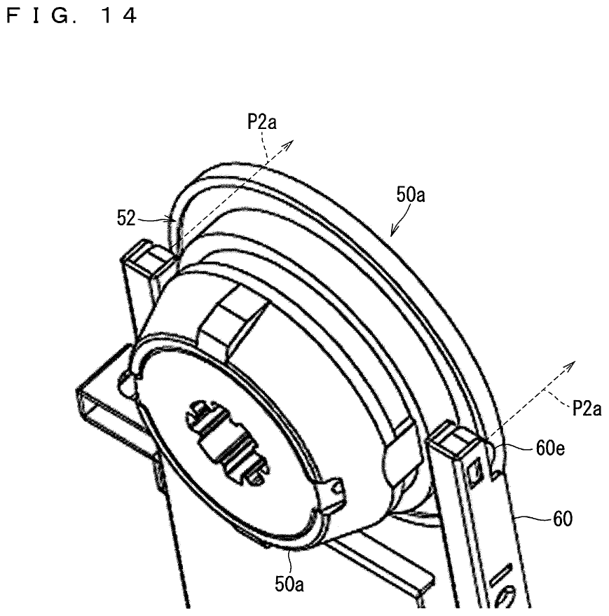

The biasing portion 60 is fixed to the base portion 19 via the spring 9. Hereinafter, the direction in which the fitting portion 50a is separated from the end portion E2a in the support state is also referred to as “direction Dr2ax” or “Dr2ax”. In addition, hereinafter, the force for moving the fitting portion 50a in the direction Dr2ax is also referred to as “force P2a” or “P2a”. FIG. 14 is a diagram showing the force P2a for moving the fitting portion 50a. In the open state, the force P2a is larger than the force P1a.

The spring 9 is configured such that the end portion 60e of the biasing portion 60 goes toward the rim portion 52 of the fitting portion 50a. For example, the spring 9 is configured such that a force is applied in the direction of the solid line arrow in FIG. 12. The spring 9 is configured such that the end portion 60e applies a force P2a to the rim portion 52 in a state where the end portion 60e is in contact with the rim portion 52 (see FIG. 14). That is, the end portion 60e (biasing portion 60) generates the force P2a. Thus, the force P2a is applied to the fitting portion 50a. Therefore, the form of the fitting portion 50a in the open state is as in FIG. 4. It should be noted that the end portion 60e (biasing portion 60) shown in FIG. 12 moves in one of the two dotted arrow directions based on the force P1a and the force P2a.

In addition, the printing apparatus 500 includes a force control member 8 that changes the force P2a according to the movable portion state of the print movable portion 200. The force control member 8 is shown in FIG. 10, for example. FIG. 10 shows a configuration in the closed state. The force control member 8 is a cam, for example. It should be noted that the force control member 8 is not limited to a cam and may be a member having another shape.

The force control member 8 is fixed to the housing Ch1. The housing Ch1 has a side surface Ch1s. The side surface Ch1s is an inner surface of the housing Ch1. The side surface Ch1s is a surface parallel to the directions Dr1a and Dr1b (XZ surface).

Specifically, the force control member 8 is fixed to the side surface Ch1s of the housing Ch1. In the closed state, the force control member 8 is fixed to the housing Ch1 so that the force control member 8 is in contact with the follower R6. In the closed state, the force control member 8 is configured such that the force control member 8 being in contact with the follower R6 prevents the biasing portion 60 (end portion 60e) from coming into contact with the fitting portion 50a (rim portion 52). In the closed state, the force P1a is greater than the force P2a.

The force control member 8 has a surface 8u and a slope 8s. In the closed state, the follower R6 is in contact with the surface 8u of the force control member 8. In this case, as in FIG. 9, the biasing portion 60 (end portion 60e) is not in contact with the fitting portion 50a (rim portion 52). For example, the end portion 60e is separated from the rim portion 52 by a distance dl.

The force control member 8 has a function of reducing the force P2a so that the force P1a becomes larger than the force P2a as the movable portion state transitions from the open state to the closed state. In addition, when the movable portion state is the open state, the force control member 8 has a function of not changing the force P2a so that the force P2a is maintained larger than the force P1a. In the open state, the force control member 8 is not in contact with the follower R6. Therefore, in the open state, the state where the force P2a is greater than the force P1a is maintained.

Next, the drive unit 40b will be described. The drive unit 40b is different from the drive unit 40a in that the drive unit 40b includes a rotation detection portion 15 instead of the drive gear 13. Since the other configurations and functions of the drive unit 40b are the same as those of the drive unit 40a, detailed description will not be repeated. In the following, a brief description will be given.

Referring to FIGS. 4 and 7, the drive unit 40b includes a fitting portion 50b, a holding portion 7, a biasing portion 12, a base portion 19, a biasing portion 60, and a rotation detection portion 15. The holding portion 7, the fitting portion 50b, and the rotation detection portion 15 are fixed to the base portion 19 of the drive unit 40b. The holding portion 7 and the fitting portion 50b are configured to be rotatable.

The fitting portion 50b is a member for fitting into the end portion E2b of the roll core 20. The fitting portion 50b is different from the fitting portion 50a in that the fitting portion 50b does not include the protruding portions X1a and X1b. Since the other configuration and shape of the fitting portion 50b are the same as those of the fitting portion 50a, detailed description will not be repeated. That is, the fitting portion 50b includes a circular truncated cone portion 51 and a rim portion 52.

Since the configuration of the biasing portion 12 and the biasing portion 60 in the drive unit 40b is the same as the configuration of the drive unit 40a, detailed description will not be repeated. Hereinafter, the direction in which the fitting portion 50b approaches the end portion E2b in the support state is also referred to as “direction Dr2b” or “Dr2b”. In addition, hereinafter, the force for moving the fitting portion 50b in the direction Dr2b is also referred to as “force P1b” or “P1b”. The biasing portion 12 of the drive unit 40b generates the force P1b in the direction Dr2b as with the configuration of the drive unit 40a.

Hereinafter, the direction in which the fitting portion 50b is separated from the end portion E2b in the support state is also referred to as “direction Dr2bx” or “Dr2bx”. In addition, hereinafter, the force for moving the fitting portion 50b in the direction Dr2bx is also referred to as “force P2b” or “P2b”. The end portion 60e (biasing portion 60) of the drive unit 40b generates the force P2b as with the configuration of the drive unit 40a.

In addition, the follower R6 is fixed to the biasing portion 60 of the drive unit 40b as with the configuration of the drive unit 40a. In addition, as with the configuration of the drive unit 40a in FIG. 10, in the closed state, another force control member 8 is fixed to the side surface of the housing Ch1 so that the other force control member 8 is in contact with the follower R6 of the biasing portion 60 of the drive unit 40b.

The rotation detection portion 15 has a function of detecting the rotation state of the fitting portion 50b. The rotation detection portion 15 has a function of detecting the rotation speed of the fitting portion 50b.

The fitting portions 50a and 50b having the above configuration move according to the change in the movable portion state. Specifically, in the support state, as the movable portion state transitions from the open state to the closed state, the fitting portion 50a fits into the end portion E2a, and the fitting portion 50b fits into the end portion E2b.

Hereinafter, the state where the fitting portion 50a fits into the end portion E2a and the fitting portion 50b fits into the end portion E2b is also referred to as a “core fitting state”. In addition, hereinafter, the state in which two or one of the state in which the fitting portion 50a fits into the end portion E2a and the state in which the fitting portion 50b fits into the end portion E2b does not occur is also referred to as a “core non-fitting state”. When the movable portion state is the open state, the core fitting state occurs, and when the movable portion state is the closed state, the core non-fitting state occurs. The core fitting state and the core non-fitting state are states of the roll core 20.

In the core fitting state, the rotational power generated by the printing apparatus 500 is transmitted to the roll core 20 via the fitting portion 50a. Thus, the fitting portion 50b fits into the end portion E2b of the roll core 20 in a driven manner.

It should be noted that the biasing portion 12 of each of the drive units 40a and 40b is configured so that the force P1a applied to the fitting portion 50a is smaller than the force P1b applied to the fitting portion 50b. Therefore, in the core fitting state, the fitting portion 50a biases the roll core 20 (end portions E2a and E2b) in the direction from the fitting portion 50a toward the fitting portion 50b.

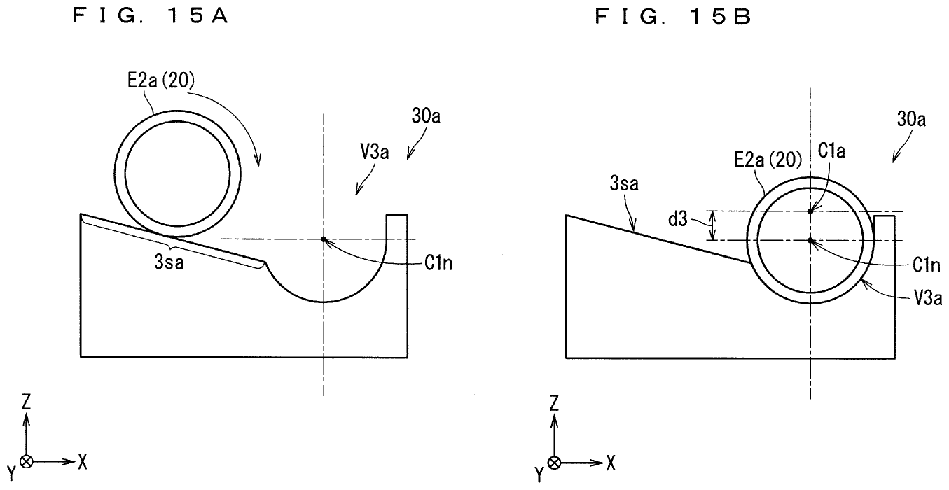

Next, the configuration of the roll core holder 30a will be described. FIGS. 15A and 15B are diagrams for illustrating the configuration of the roll core holder 30a according to the first embodiment. FIG. 15A is a diagram for illustrating a characteristic configuration of the roll core holder 30a. FIG. 15B shows a state of the roll core holder 30a in the supported state. In the support state, the support portion V3a supports the end portion E2a of the roll core 20, and the support portion V3b supports the end portion E2b.

Referring to FIGS. 15A and 15B, the roll core holder 30a is provided with the support portion V3a as a recess and a slope 3sa. The slope 3sa is provided in the roll core holder 30a so that the slope 3sa guides the end portion E2a of the roll core 20 to the support portion V3a.

A virtual central axis is formed by the support portion V3a (recess) of the roll core holder 30a and the support portion V3b (recess) of the roll core holder 30b. Hereinafter, the position of the virtual central axis is also referred to as “center position C1n”. In addition, hereinafter, the position of the central axis of the fitting portion 50a in the core fitting state is also referred to as “center position C1a”. The center position C1a is also the position of the center of the side surface of the roll core 20 in the core fitting state.

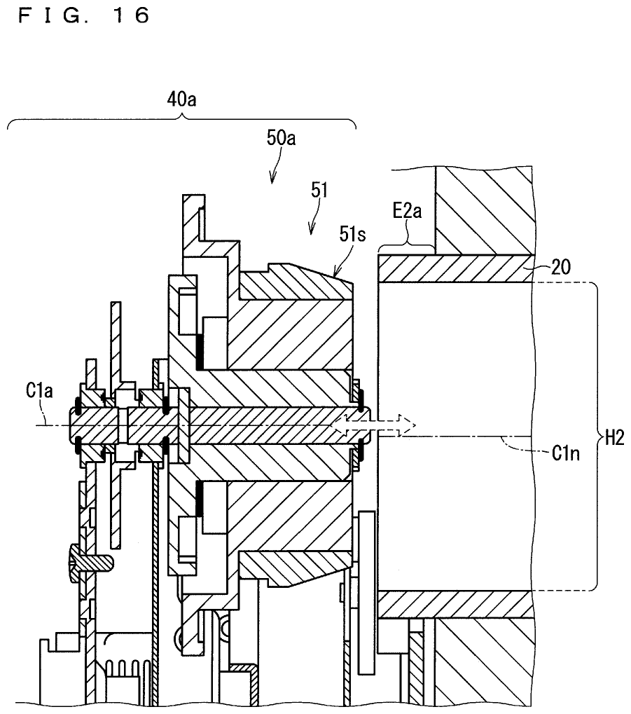

FIG. 16 is a cross-sectional view of the drive unit 40a and the roll core 20 in the support state and the core non-fitting state. FIG. 16 shows the center positions C1n and C1a.

Referring to FIGS. 15B and 16, in the vertical direction (Z-axis direction), the center position C1a is different from the center position C1n. The center position C1a is separated from the center position C1n by a distance d3.

In the support state, as the movable portion state transitions from the open state to the closed state, the fitting portion 50a fits into the end portion E2a. That is, the core fitting state occurs. In the core fitting state, the center position C1a and the center position C1n are set so that the end portion E2a of the roll core 20 is not in contact with the support portion V3a. It should be noted that the center position C1a is the position of the central axis of rotation of the fitting portion 50a. That is, the fitting portion 50a is configured such that the end portion E2a is not in contact with the support portion V3a in a state where the fitting portion 50a fits into the end portion E2a.

Hereinafter, the operation of the user and the printing apparatus 500 for attaching the paper roll 4r to the printing apparatus 500 is also referred to as “attaching operation”. In addition, hereinafter, the state in which the paper roll 4r is attached to the printing apparatus 500 is also referred to as “roll attached state”.

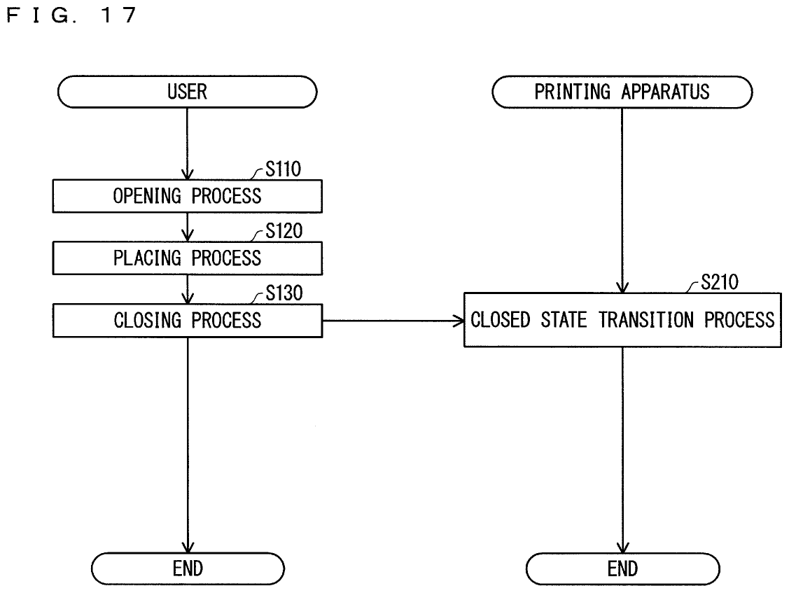

Next, the attaching operation will be described based on FIG. 17. FIG. 17 is a flowchart for illustrating the attaching operation. First, an operation until the user temporarily places the paper roll 4r on the roll core holder unit 30u will be described.

Referring to FIG. 17, first, an opening process is performed (S110). In the opening process, the user moves the print movable portion 200 in the direction Dr1a so that the state of the print movable portion 200 (movable portion state) is the open state (see FIG. 1). Specifically, the user moves the print movable portion 200 in the direction Dr1a so that the roll core holder unit 30u is exposed to the outside. Thus, the state of the print movable portion 200 becomes as in FIG. 3.

Next, a placing process is performed (S120). In the placing process, the user temporarily places the paper roll 4r. Specifically, the user places the paper roll 4r on the roll core holder unit 30u so that the end portion E2a of the roll core 20 is in contact with the slope 3sa of the roll core holder 30a and the end portion E2b is in contact with the slope 3sb of the roll core holder 30b.

Thus, the end portion E2a moves to the support portion V3a while the end portion E2a rotates on the slope 3sa due to the own weight of the paper roll 4r. Thus, the support portion V3a supports the end portion E2a.

Simultaneously with the movement of the end portion E2a, the end portion E2b moves to the support portion V3b constituted by the rollers R3a and R3b while rotating on the slope 3sb. Thus, the support portion V3b supports the end portion E2b. Therefore, the state of the support portion V3 is the support state. Thus, temporary placement of the paper roll 4r is completed.

In the support state, the position of the central axis of the roll core 20 coincides with the position of the virtual central axis (center position C1n). Therefore, the fitting accuracy between each of the fitting portions 50a and 50b and the roll core 20 in the core fitting state can be improved.

The configuration of the roll core holders 30a and 30b automatically determines the position of the roll core 20 even without the user being aware of the position on which the paper roll 4r is placed. Therefore, the user can easily perform temporary placement for attaching the paper roll 4r to the printing apparatus 500.

It should be noted that it is conceivable that the user performs an insertion operation in the state of temporary placement (supported state). The insertion operation is an operation for conveying the paper 4 to a position where the tip of the paper 4 is sandwiched between the conveyance roller R1a and the pinch roller R1b. That is, the insertion operation is also an operation of rotating the paper roll 4r.

In the present embodiment, a roller for supporting the end portion E2a of the roll core 20 is not provided on the support portion V3a (recess) side of the roll core holder 30a. It should be noted that the end portion E2a is provided with recessed portions V1a and V1b. In addition, the roll core holder 30b is provided with rollers R3a and R3b for supporting the end portion E2b of the roll core 20. It should be noted that the end portion E2b is not provided with a recessed portion.

With this configuration, the support portion V3a of the roll core holder 30a supports by line contact the region other than the recessed portions V1a and V1b of the end portion E2a. Therefore, even if the user performs an operation of rotating the paper roll 4r, the user can easily attach the paper roll 4r to the printing apparatus 500 without causing a state where the roll core 20 rattles.

Hereinafter, a user who is not used to handling the printing apparatus 500 is also referred to as “user N”. The user N is a user who operates the printing apparatus 500 for the first time, for example. If the roll core 20 rattles when the paper roll 4r is attached to the printing apparatus 500, the user N feels uneasy that a problem has occurred. The problem is a problem that the printing apparatus has failed, for example. In addition, the problem is such that a paper roll is erroneously attached, for example.

However, the printing apparatus 500 of the present embodiment (for example, the roll core holder 30a) is configured as described above. Therefore, when the paper roll 4r is attached to the printing apparatus 500, a state in which the roll core 20 rattles does not occur. Therefore, the user N can easily attach the paper roll 4r to the printing apparatus 500 without feeling uneasy as described above.

Next, a closing process is performed (S130). In the closing process, in the support state, the user moves the print movable portion 200 in the direction Dr1b so that the state of the print movable portion 200 (movable portion state) transitions from the open state to the closed state (see FIG. 3). Thus, the state of the print movable portion 200 becomes the closed state (see FIG. 1).

As the print movable portion 200 moves, the drive units 40a and 40b included in the roll holding portion 400 also move in the direction Dr1b (X direction). It should be noted that in the open state, the follower R6 is not in contact with the force control member 8 fixed to the housing Ch1. That is, in the open state, the force control member 8 does not change the force P2a so that a state where the force P2a is larger than the force P1a is maintained. Therefore, in the open state, the force P2a is larger than the force P1a.

The state of the drive units 40a and 40b in the open state is the state in FIGS. 4 and 6. The force control member 8 reduces the force P2a so that the force P1a becomes larger than the force P2a as the movable portion state transitions from the open state to the closed state.

As the closing process is started, in the printing apparatus 500, a closed state transition process is performed (S210).

Hereinafter, the period in which performing the closing process moves the print movable portion 200 in the direction Dr1b is also referred to as a “movement period”. The closed state transition process is performed over the movement period. In addition, over the movement period, the drive units 40a and 40b move in the direction Drib. It should be noted that the position of the force control member 8 (housing Ch1) does not change over the movement period. Hereinafter, in order to simplify the description, the operation of the drive unit 40a will be mainly described.

In the closed state transition process, as the drive unit 40a moves in the direction Dr1b in the movement period, the follower R6 moves toward the surface 8u in a state of being in contact with the slope 8s of the force control member 8 in FIG. 10. The force with which the force control member 8 pushes the follower R6 gradually increases as the follower R6 in contact with the slope 8s approaches the surface 8u.

Therefore, the follower R6 gradually moves in the direction Dr2a. Therefore, the biasing portion 60 to which the follower R6 is fixed rotates so that the fitting portion 50a moves in the direction Dr2a. Thus, the force P1a gradually increases and the force P2a gradually decreases.

Next, the closed state transition process will be described in detail. At the initial stage of the movement period, the follower R6 comes into contact with the slope 8s of the force control member 8 in FIG. 10. In addition, at the initial stage of the movement period, the follower R6 gradually moves toward the surface 8u in a state of being in contact with the slope 8s. It should be noted that the follower R6 is fixed to the biasing portion 60. Therefore, the biasing portion 60 in FIG. 6 rotates so that the fitting portion 50a gradually moves in the direction Dr2a and the fitting portion 50b gradually moves in the direction Dr2b.

It should be noted that the biasing portion 12 of the drive unit 40a biases the fitting portion 50a in the direction Dr2a. The biasing portion 12 of the drive unit 40b biases the fitting portion 50b in the direction Dr2b.

At the middle stage of the movement period, the circular truncated cone portion 51 of each of the fitting portions 50a and 50b begin to enter the hole H2 of the roll core 20 (see FIG. 16). Hereinafter, the surface in contact with the hole H2 of the end portion E2a is also referred to as an “inner surface”. In addition, hereinafter, the end of the inner surface is also referred to as “inner surface end”.

Thereafter, the slope 51s of the circular truncated cone portion 51 of each of the fitting portions 50a and 50b comes into contact with the end portion of the roll core 20. For example, the slope 51s of the circular truncated cone portion 51 of the fitting portion 50a comes into contact with the inner surface end of the end portion E2a of the roll core 20. In addition, the fitting portion 50a moves in the direction Dr2a in a state where the inner surface end of the end portion E2a is in contact with the slope 51s.

It should be noted that until the inner diameter D1a of the roll core 20 and the outer diameter of the circular truncated cone portion 51 of each of the fitting portions 50a and 50b match, the circular truncated cone portion 51 of each of the fitting portions 50a and 50b moves toward the inside of the hole H2.

Thus, as the movable portion state becomes the closed state, the fitting portion 50a fits into the end portion E2a, and the fitting portion 50b fits into the end portion E2b. That is, a core fitting state (roll attached state) occurs. In a state where the core fitting state (roll attached state) occurs, the roll core 20 is separated from the roll core holders 30a and 30b.

As described with reference to FIGS. 15A, 15B and 16, this situation occurs because the center positions C1a and C1n are set so that the end portion E2a is not in contact with the support portion V3a in the core fitting state. In the core fitting state, the roll core 20 is held by the fitting portions 50a and 50b in a state of being separated from the roll core holders 30a and 30b. With the above, the closed state transition process ends.

In the closed state and the core fitting state, the roll core 20 is held by the fitting portions 50a and 50b in a state of being separated from the roll core holders 30a and 30b. Therefore, it is possible to prevent a problem due to vibration caused when the printing apparatus 500 is transported from occurring, for example. The problem is such that powder or the like is generated between the roll core holder and the roll core 20, for example. In addition, the problem is such that the roll core holder, the roll core 20, and the like are broken, for example.

In addition, the printing apparatus 500 can be transported in a state of the paper roll 4r being attached to the printing apparatus 500. Therefore, it is not necessary to perform a packing operation of packing the paper roll 4r apart from the packing of the printing apparatus 500. Therefore, the volume necessary for transporting the printing apparatus 500 and the paper roll 4r can be limited to the volume of the printing apparatus 500. As a result, the transportation cost of the printing apparatus 500 and the paper roll 4r can be reduced.

In addition, the shape of the circular truncated cone portion 51 of each of the fitting portions 50a and 50b is a circular truncated cone. Therefore, even when the roll core 20 is temporarily placed on the roll core holder, the state of the print movable portion 200 transitioning from the open state to the closed state causes the fitting portions 50a and 50b to fit into the hole H2 of the roll core 20.

In addition, the diameter of the circle Cr1 included in the circular truncated cone is smaller than the inner diameter D1a of the roll core 20. In addition, the diameter of the circle Cr2 included in the circular truncated cone is larger than the outer diameter D1b of the roll core 20. Therefore, the roll core 20 is held in a state where the inner diameter D1a of the roll core 20 matches the outer diameter of the circular truncated cone portion 51 of each of the fitting portions 50a and 50b.

In addition, in the core fitting state, the fitting portion 50a biases the end portion E2b in the direction from the fitting portion 50a toward the fitting portion 50b. In addition, the roll core 20 is held in a state where the central axis of each of the fitting portions 50a and 50b and the central axis of the roll core 20 coincide. Therefore, the printing apparatus 500 can hold the roll core 20 with high accuracy.

Therefore, when the printing processing is performed, the rotational power applied to the roll core 20 is accurately transmitted to the paper roll 4r. Therefore, the user can obtain a high-quality printed matter. The printed matter does not have a striped pattern occurring when the rotational power transmission accuracy is poor, for example.

It should be noted that the roll holding portion 400 is configured such that the core fitting state (roll attached state) occurs as the movable portion state becomes the closed state. In addition, when the state of the print movable portion 200 (movable portion state) transitions from the open state to the closed state, the above-described closed state transition process is performed. Therefore, after temporarily placing the paper roll 4r, just moving the print movable portion 200 in the direction Drib so that the movable portion state transitions from the open state to the closed state allows the user to attach the paper roll 4r to the printing apparatus 500.

It should be noted that when the paper roll 4r needs to be replaced, the following operation is performed. The user moves the print movable portion 200 in the direction Dr1a so that the state of the print movable portion 200 (movable portion state) becomes the open state. Thus, the state of the roll core 20 transitions from the core fitting state to the core non-fitting state. Therefore, the user can easily take out the paper roll 4r from the printing apparatus 500.

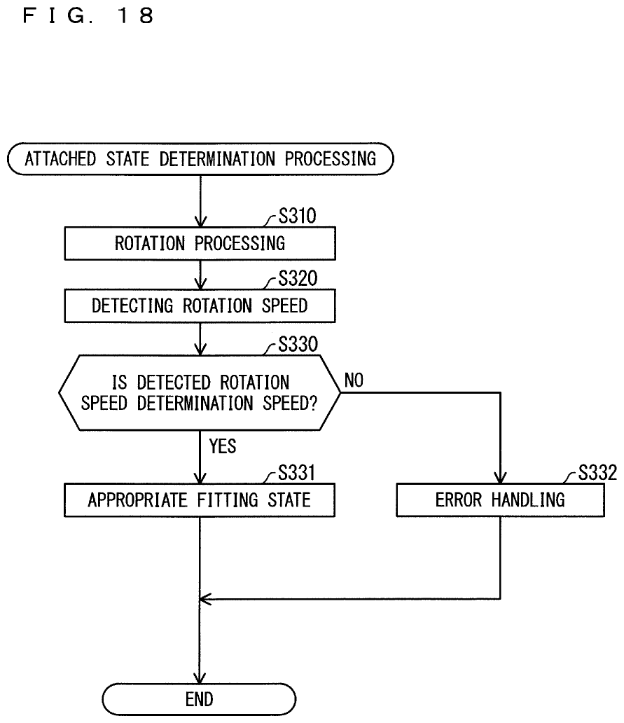

Next, processing based on the attached state of the paper roll 4r (hereinafter also referred to as “attached state determination processing”) will be described. The attached state determination processing is performed in the roll attached state. FIG. 18 is a flowchart of the attached state determination processing according to the first embodiment. The attached state determination processing is processing for determining whether the paper roll 4r is appropriately attached to the printing apparatus 500. In the attached state determination processing, although details will be described below, the printing apparatus 500 performs processing for notifying an error based on the rotation state of the fitting portion 50b detected by the rotation detection portion 15.

The attached state determination processing is performed after the printing apparatus 500 detects that the state of the print movable portion 200 (movable portion state) is the closed state. Hereinafter, the state of the roll core 20 when the fitting portions 50a and 50b appropriately fit into the roll core 20 is also referred to as “appropriate fitting state”. The appropriate fitting state is also a state in which the paper roll 4r is appropriately attached to the printing apparatus 500. In addition, hereinafter, the state of the roll core 20 when both or one of the fitting portions 50a and 50b does not appropriately fit into the roll core 20 is also referred to as “inappropriate fitting state”.

In the attached state determination processing, first, rotation processing is performed (S310). In the rotation processing, the printing apparatus 500 rotates the fitting portion 50a at a predetermined speed. When the state of the roll core 20 is the appropriate fitting state, the rotation speed of the fitting portion 50b is included in the determination speed. The determination speed is a speed for determining whether the state of the roll core 20 is an appropriate fitting state. The determination speed is set to a speed at which an error or the like is taken into consideration with respect to the rotation speed of the fitting portion 50a rotating by the rotation processing, for example. The determination speed is a rotation speed k times the rotation speed of the fitting portion 50a rotating by the rotation processing, for example. k is a value in the range of 0.9 to 1.1, for example.

The rotation detection portion 15 detects the rotation speed (rotation state) of the fitting portion 50b (S320). Hereinafter, the rotation speed of the fitting portion 50b detected by the rotation detection portion 15 is also referred to as “detected rotation speed”.

When the fitting portion 50a does not appropriately fit into the roll core 20 (end portion E2a), the position of the central axis of the roll core 20 does not coincide with the position of the rotation central axis of the fitting portion 50a. Therefore, the rotation speed of the roll core 20 does not coincide with the rotation speed of the fitting portion 50a. In this case, the detected rotation speed detected by the rotation detection portion 15 is a speed different from the determination speed. In addition, when the fitting portion 50b does not appropriately fit into the roll core 20 (end portion E2b), the detected rotation speed detected by the rotation detection portion 15 is a speed different from the determination speed.

Next, it is determined whether the detected rotation speed is a determination speed (S330). If the detected rotation speed is the determination speed (YES in S330), the control portion (not shown) of the printing apparatus 500 determines that the state of the roll core 20 is the appropriate fitting state (S331). That is, the control portion determines that the attachment of the paper roll 4r is appropriately completed. Then, the attached state determination processing ends.

It should be noted that if the detected rotation speed is not the determination speed (NO in S330), the processing proceeds to step S332. In step S332, error handling is performed. The error handling is processing for notifying the user of an error. The error handling is processing of notifying the user that the paper roll 4r is not appropriately attached to the printing apparatus 500, for example.

In the error handling, a message is displayed on a liquid crystal screen (not shown) provided in the printing apparatus 500, for example. The message is a message “The paper roll is not appropriately attached to the printing apparatus”, for example. In addition, in the error handling, a beep sound is output from a speaker (not shown) provided in the printing apparatus 500, for example. When the error handling ends, the attached state determination processing ends.

As described above, according to the present embodiment, the movable portion state being a state of the print movable portion 200 including the roll core holder unit 30u configured to support the end portion E2a and the end portion E2b of the roll core 20 has an open state and a closed state. The print movable portion 200 is configured to be movable so that the movable portion state is the open state or the closed state. The roll core holder unit 30u is provided with a support portion V3. In a support state in which the support portion V3 supports the end portion E2a and the end portion E2b, as the movable portion state transitions from the open state to the closed state, the fitting portion 50a fits into the end portion E2a and the fitting portion 50b fits into the end portion E2b.

Thus, it is possible to provide a printing apparatus having a configuration for holding the roll core in a state where the roll core holder unit supports the roll core.

In addition, according to the present embodiment, after temporarily placing the paper roll 4r, just moving the print movable portion 200 in the direction Drib so that the movable portion state transitions from the open state to the closed state allows the user to attach the paper roll 4r to the printing apparatus 500. Therefore, the attachment or replacement of the paper roll 4r can be performed very easily.

In addition, according to the present embodiment, the force control member 8 reduces the force P2a so that the force P1a becomes larger than the force P2a as the movable portion state transitions from the open state to the closed state. Thus, the fitting portions 50a and 50b are biased toward the end portion of the roll core 20. Accordingly, each of the fitting portions 50a and 50b fits into the hole H2 of the roll core 20. Therefore, the fitting portions 50a and 50b hold the roll core 20 in a state where the rotational power generated by the printing apparatus 500 can be transmitted to the roll core 20.

Thus, the user can easily attach the paper roll 4r to the printing apparatus 500 without performing the work of attaching the paper flange to the paper roll. Therefore, even the user N who is not familiar with the handling of the printing apparatus 500 can easily attach the paper roll 4r to the printing apparatus 500.

In addition, according to the present embodiment, in order to attach the paper roll to the printing apparatus, the user does not need to perform the conventional operation of attaching the paper flange to the paper roll.

It should be noted that the printing apparatus 500 may have a configuration being a monochrome printing apparatus that does not require a paper flange. In the configuration, the user temporarily places the paper roll 4r on the roll core holder unit 30u. Then, the user moves the print movable portion 200 so that the movable portion state becomes the closed state. The user completes the attachment of the paper roll 4r only by performing such an operation. Therefore, the user can perform the attachment or replacement of the paper roll 4r very easily.

In addition, in the closed state, as shown in FIG. 9, the biasing portion 60 (end portion 60e) is not in contact with the (rim portion 52) of the fitting portions 50a and 50b. Therefore, in the printing processing, no frictional resistance occurs between the biasing portion 60 and the fitting portion 50a (fitting portion 50b) in a state where the fitting portions 50a and 50b rotate.

As a result, the fitting portions 50a and 50b rotate smoothly. Thus, the paper roll 4r rotatably held by the fitting portions 50a and 50b also smoothly rotates. In addition, in the printing processing, the paper roll 4r rotating smoothly allows the user to obtain a high-quality printed matter. The printed matter does not have a striped pattern or the like caused by the paper roll 4r not rotating smoothly, for example.

In addition, since no frictional resistance occurs between the biasing portion 60 and the fitting portion 50a (fitting part 50b) in a state where the fitting portions 50a and 50b rotate, wear of parts due to friction does not occur. Therefore, the life of the printing apparatus 500 is also improved. As a result, the running cost in the printing apparatus 500 can be reduced. In addition, the frequency of product replacement can be reduced. Therefore, resource saving can be achieved.

In addition, according to the present embodiment, the biasing portion 12 of each of the drive units 40a and 40b is configured such that the force P1a applied to the fitting portion 50a is smaller than the force P1b applied to the fitting portion 50b. Therefore, in the core fitting state, the fitting portion 50a biases the roll core 20 (end portions E2a and E2b) in the direction from the fitting portion 50a toward the fitting portion 50b.

Thus, the paper roll 4r is biased toward the fitting portion 50b. Therefore, the center of the paper roll 4r in the width direction with respect to the printing apparatus 500 is stably positioned. Therefore, a misalignment is unlikely to occur between the center position of the image printed on the paper and the center position in the width direction of the paper. As a result, the center position of the image to be printed designated by the user matches the center position of the paper. Thus, it is possible to obtain a printed matter as intended by the user.

In addition, according to the present embodiment, the above-described attached state determination processing is performed after the printing apparatus 500 detects that the state of the print movable portion 200 (movable portion state) is the closed state. Performing the attached state determination processing makes it possible to detect a state where the fitting portions 50a and 50b do not appropriately fit into the roll core 20. When the state of the roll core 20 is an inappropriate fitting state, for example, error handling for notifying the user that the fitting state is inappropriate is performed. Thus, it is possible to prompt the user to perform the operation of re-attaching the paper roll 4r. As a result, the user can always obtain a high-quality printed matter.

In addition, as in FIG. 2, the end portion E2a of the roll core 20 is provided with recessed portions V1a and V1b. In addition, the fitting portion 50a is provided with protruding portions X1a and X1b. The protruding portions X1a and X1b are components for fitting into the recessed portions V1a and V1b, respectively.

Assume that the recessed portion of the roll core 20 and the protruding portion of the fitting portion 50a do not fit to each other in a state where the paper roll 4r described above is temporarily placed. In addition, assume that rotation of the fitting portion 50a arranges the recessed portion of the roll core 20 and the protruding portion of the fitting portion 50a in a linear fashion. It should be noted that the fitting portion 50a is always biased toward the end portion E2a of the roll core 20 by the biasing portion 12. Therefore, the protruding portion of the fitting portion 50a fits into the recessed portion of the end portion E2a.

Thus, the rotational power generated by the printing apparatus 500 can be reliably transmitted to the roll core 20. Therefore, it is possible to accurately control the rotation state of the roll core 20. Accordingly, the rotation speed of the roll core 20 can be stabilized. Therefore, the roll core 20 can be smoothly rotated in the printing processing. As a result, the user can obtain a high-quality printed matter. The printed matter has no striped pattern or the like caused by the roll core 20 (paper roll 4r) not rotating smoothly, for example.

In addition, only one end portion (end portion E2a) of the roll core 20 is provided with a recessed portion. Therefore, when attaching the paper roll 4r to the printing apparatus 500, the user can easily distinguish the end portion E2a (right end portion) and the end portion E2b (left end portion) of the paper roll 4r. Accordingly, the paper roll 4r can be easily attached to the printing apparatus 500.

It should be noted that the related configurations A and B show a technique relating to improving attaching property of the paper flange. In the related configurations A and B, when the paper roll is attached to the printing apparatus, it is necessary to attach the paper flange to the paper roll. Therefore, in the related configurations A and B, there is a problem that an operation of attaching the paper flange to the paper roll is necessary.

In addition, in the related configuration C, when the paper roll is attached to the printing apparatus, it is not necessary to attach the paper flange to the paper roll. It should be noted that when the user attaches the paper roll to the printing apparatus, the roll paper holder needs to be deformed. Therefore, there is annoyance when the paper roll is attached.

In addition, in the related configuration C, when a paper roll having a large diameter is used, it is necessary to sandwich and hold the paper tube portion of the paper roll with both hands. Therefore, in the case of a paper roll having a large diameter, both hands and the roll paper holder interfere when the roll paper holder is deformed. Therefore, in the related configuration C, there is a problem that it is difficult to attach a paper roll having a large diameter to the printing apparatus.

Thus, the printing apparatus 500 of the present embodiment has the above configuration. Therefore, the user does not need to perform an operation of attaching the paper flange to the paper roll. In addition, unlike in the related configuration C, it is not necessary to perform an operation of deforming the roll paper holder even on a printing apparatus that does not require a paper flange. Accordingly, the printing apparatus 500 of the present embodiment can solve the above problems.

### First Modification

Hereinafter, the configuration of the first embodiment is also referred to as “configuration Ct1”. In addition, the configuration of the present modification is also referred to as “configuration Ctm1”. The configuration Ctm1 is a configuration for extruding the roll core 20 from the support portion. The configuration Ctm1 is applied to the configuration Ct1 (first embodiment).

In the first embodiment, in the closed state, the roll core 20 is held by the fitting portions 50a and 50b in a state of being separated from the roll core holders 30a and 30b, but the present invention is not limited to this. Even in the closed state and the core fitting state, the roll core 20 may be supported by the support portions of the roll core holders 30a and 30b. That is, the support state may occur in the closed state and the core fitting state. The configuration Ctm1 will be described as a configuration in which a closed state and a support state are generated.

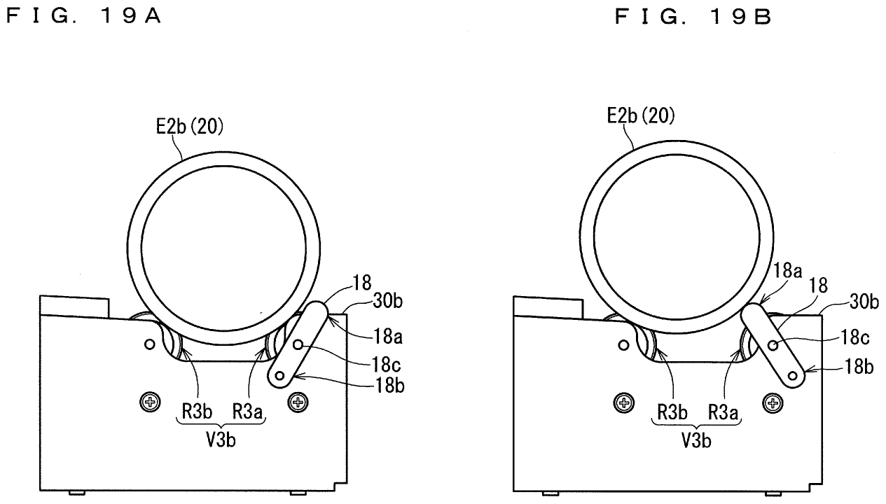

FIGS. 19A and 19B are diagrams showing the roll core holder 30b of the roll core holder unit 30u according to the first modification. The roll core holder unit 30u having the configuration Ctm1 is provided with a biasing member 18. Specifically, in the configuration Ctm1, the roll core holder 30b is provided with the biasing member 18.

FIG. 19A is a diagram showing the configuration of the roll core holder 30b in the support state and the closed state. In the support state, the end portion E2b of the roll core 20 is supported by the support portion V3b configured by the rollers R3a and R3b.

FIG. 19B is a diagram showing the configuration of the roll core holder 30b in the non-support state and the open state. The non-support state in FIG. 19B is a state where the support portion V3b does not support the end portion E2b.

Referring to FIGS. 19A and 19B, the shape of the biasing member 18 is a long shape. The biasing member 18 includes end portions 18a and 18b. The biasing member 18 is configured to be rotatable around the rotating shaft 18c. The biasing member 18 is configured to push the roll core 20.

In the open state, the biasing member 18 is configured to maintain the state in FIG. 19B by a spring (not shown) or the like, for example. A cam Cm1 (not shown) is fixed to the side surface Ch1s of the housing Ch1.

Here, assume that the print movable portion 200 (roll core holder 30b) has moved in the direction Dr1b so that the state of the print movable portion 200 transitions from the open state to the closed state. In this case, the cam Cm1 is configured such that the cam Cm1 comes into contact with the end portion 18b of the biasing member 18 as the roll core holder 30b moves.

In the closed state in FIG. 19A, the cam Cm1 is in contact with the end portion 18b of the biasing member 18 so that the biasing member 18 (end portion 18a) does not come into contact with the roll core 20 (end portion E2b). That is, the biasing member 18 is not in contact with the roll core 20 in the support state and the closed state.

Next, the operation of the biasing member 18 will be described. Here, assume that the state of the biasing member 18 is the state in FIG. 19A. That is, assume that the state of the print movable portion 200 is the closed state and the support portion V3b (rollers R3a and R3b) supports the end portion E2b (roll core 20).

In this situation, the user moves the print movable portion 200 in the direction Dr1a so that the state of the print movable portion 200 (movable portion state) is the open state. As the print movable portion 200 moves, the cam Cm1 moves away from the end portion 18b of the biasing member 18. Thus, the biasing member 18 rotates counterclockwise so as to be in the state in FIG. 19B.

As the biasing member 18 rotates, the biasing member 18 (end portion 18a) pushes the end portion E2b (roll core 20) so that the end portion E2b (roll core 20) moves away from the support portion V3b (rollers R3a and R3b). That is, in the support state, when the movable portion state transitions from the closed state to the open state, the biasing member 18 pushes the roll core 20 so that the state of the support portion V3 (support portion V3b) transitions from the support state to the non-support state.

It should be noted that the roll core holder 30a is also provided with a biasing member 18 having a configuration similar to the configuration of the biasing member 18 of the roll core holder 30b.

As described above, in the present modification, moving the print movable portion 200 in the direction Dr1a by the user so that the state of the print movable portion 200 (movable portion state) is the open state causes the roll core 20 to be extruded from the support portion V3b of the roll core holder 30b. Therefore, the user can take out the paper roll 4r from the printing apparatus 500 by putting his hand into the hole H2 of the roll core 20 even without holding the outer peripheral surface of the paper roll 4r. Therefore, the paper roll 4r can be easily replaced.

It should be noted that the present modification has a configuration in which a support state is generated in the closed state, but the present invention is not limited to this configuration. For example, in the process in which the state of the print movable portion 200 transitions from the open state to the closed state, the operation timing of the biasing member 18 may be set so that the biasing member 18 (end portion 18a) rotates in a direction away from the roll core 20 and thereafter the biasing portion 60 and the biasing portion 12 act.

It should be noted that in the present invention, the embodiment and the modification can be freely combined, and the embodiment and the modification can be appropriately modified or omitted within the scope of the present invention.

For example, a configuration in which movement in the horizontal direction by the print movable portion 200 generates an open state or a closed state is described, but the present invention is not limited thereto. For example, a configuration in which rotation by the print movable portion 200 generates an open state or a closed state may be used. In the configuration, the housing Ch1 is provided with a rotation axis, for example. The print movable portion 200 rotates with the rotation axis as a rotation center.

It should be noted that in the first embodiment, in the core fitting state, the fitting portion 50a biases the roll core 20 (end portions E2a and E2b) in the direction from the fitting portion 50a toward the fitting portion 50b. Thus, the biasing force may be configured to be received by the cylindrical side surfaces of the rollers R3a and R3b of the roll core holder 30b.

In addition, for example, the biasing portion 12 of each of the drive units 40a and 40b is configured such that the force P1a applied to the fitting portion 50a is smaller than the force P1b applied to the fitting portion 50b, but the present invention is not limited thereto. The force P1a applied to the fitting portion 50a may be the same as the force P1b applied to the fitting portion 50b. In this case, in the core fitting state, the fitting portion 50a does not bias the roll core 20 (end portions E2a and E2b) in the direction from the fitting portion 50a toward the fitting portion 50b.

Although the present invention is described in detail, the above description is in all aspects illustrative, and the present invention is not limited to the above description. It is understood that innumerable modifications not illustrated can be envisaged without departing from the scope of the present invention.

### EXPLANATION OF REFERENCE SIGNS

4r: paper roll
8: force control member
12: biasing portion
15: rotation detection portion
18: biasing member
20: roll core
30a, 30b: roll core holder
30u: roll core holder unit
40a, 40b: drive unit
50a, 50b: fitting portion
51: circular truncated cone portion
60: biasing portion
200: print movable portion
Substitute Specification
400: roll holding portion
500: printing apparatus
Ch1: housing
R3a, R3b: roller

1. A printing apparatus using a paper roll configured by winding long paper around a cylindrical roll core in a roll-shaped manner, the printing apparatus having a function of forming an image on the paper, the printing apparatus comprising:
a print movable portion having a configuration for holding the paper roll; and
a housing for accommodating the print movable portion,
wherein the print movable portion includes:
a roll core holder unit configured to support one end portion and another end portion of the roll core;
a first fitting portion for fitting into the one end portion of the roll core; and
a second fitting portion for fitting into the other end portion of the roll core,
in a movable portion state being a state of the print movable portion, there exist an open state where the roll core holder unit is not covered with the housing and a closed state where the roll core holder unit is covered with the housing,
the print movable portion is configured to be movable so that the movable portion state is the open state or the closed state,
the roll core holder unit is provided with a support portion for supporting the one end portion and the other end portion of the roll core,
in a state of the support portion, there exist a support state in which the support portion supports the one end portion and the other end portion, and a non-support state in which the support portion does not support both or one of the one end portion and the other end portion,
each of the first fitting portion and the second fitting portion is configured to be rotatable, and
in the support state, as the movable portion state transitions from the open state to the closed state, the first fitting portion fits into the one end portion and the second fitting portion fits into the other end portion.

2. The printing apparatus according to claim 1, wherein
the print movable portion further includes:
a first biasing portion configured to generate a first force for the first fitting portion to move in a first direction being a direction in which the first fitting portion in the support state; and
a second biasing portion configured to generate a second force larger than the first force for the first fitting portion to move in a second direction being a direction in which the first fitting portion separates from the one end portion in the support state,
the printing apparatus further includes a force control member configured to change the second force according to the movable portion state of the print movable portion, and
the force control member has:
a function of reducing the second force so that the first force becomes larger than the second force as the movable portion state transitions from the open state to the closed state; and
a function of not changing the second force so as to maintain a state in which the second force is larger than the first force when the movable portion state is the open state.

3. The printing apparatus according to claim 2, wherein
a follower being disc-shaped is fixed to the second biasing portion,
in the closed state, the force control member is fixed to the housing so that the force control member is in contact with the follower, and
in the closed state, the force control member is configured such that the force control member being in contact with the follower prevents the second biasing portion from coming into contact with the first fitting portion.

4. The printing apparatus according to claim 1, wherein
each of the first fitting portion and the second fitting portion has a circular truncated cone portion,
a shape of the circular truncated cone portion is a circular truncated cone,
the circular truncated cone has a first circle and a second circle larger than the first circle,
a diameter of the first circle is smaller than an inner diameter of the roll core, and
a diameter of the second circle is larger than an outer diameter of the roll core.

5. The printing apparatus according to claim 1, wherein
the one end portion of the roll core is provided with a recessed portion, and
the first fitting portion is provided with a protruding portion configured to fit into the recessed portion.

6. The printing apparatus according to claim 1, wherein
the roll core holder unit includes a first roll core holder for supporting the one end portion of the roll core,
the support portion includes a first support portion for supporting the one end portion,
the first support portion is a recess,
the first roll core holder is provided with the first support portion and a slope, and
the slope is provided in the first roll core holder so that the slope guides the one end portion to the first support portion.

7. The printing apparatus according to claim 6, wherein
in the support state, the first support portion supports the one end portion,
in the support state, as the movable portion state transitions from the open state to the closed state, the first fitting portion fits into the one end portion, and
the first fitting portion is configured such that the one end portion is not in contact with the first support portion in a state where the first fitting portion fits into the one end portion.

8. The printing apparatus according to claim 1, wherein
the roll core holder unit includes a second roll core holder for supporting the other end portion of the roll core, and
the second roll core holder is provided with rollers for supporting the other end portion.

9. The printing apparatus according to claim 8, wherein
in a state where the first fitting portion fits into the one end portion and the second fitting portion fits into the other end portion, the first fitting portion biases the roll core in a direction from the first fitting portion toward the second fitting portion.

10. The printing apparatus according to claim 1, further comprising a rotation detection portion configured to detect a rotation state of the second fitting portion,
wherein
the printing apparatus performs processing for notifying an error based on the rotation state being detected.

11. The printing apparatus according to claim 1, wherein
the roll core holder unit is provided with a biasing member,
the biasing member is configured to push the roll core,
in the support state and the closed state, the biasing member is not in contact with the roll core, and
in the support state, when the movable portion state transitions from the closed state to the open state, the biasing member pushes the roll core so that a state of the support portion transitions from the support state to the non-support state.
